(19) United States
(12) Patent Application Publication
(10) Pub. No.: US 2025/0007386 A1
(43) Pub. Date: Jan. 2, 2025

(54) SWITCHING METHODS AND APPARATUS CONFIGURED FOR USE WITH CYCLOCONVERTERS

(71) Applicant: Enphase Energy, Inc., Petaluma, CA (US)

(72) Inventors: Indra PRAKASH, Bangalore (IN); Pavan Kumar GUDIPALLI, Bangalore (IN); Mrinmoy SAHA, Kolkata (IN); Navin KUMAR, Jharkhand (IN)

(21) Appl. No.: 18/748,651

(22) Filed: Jun. 20, 2024

(30) Foreign Application Priority Data
Jul. 2, 2023 (IN) 202311044294

(51) Int. Cl. H02M 1/08; H02M 1/00; H02M 3/00; H02M 3/335

(52) U.S. Cl. CPC H02M 1/083; H02M 1/0058; H02M 3/01; H02M 3/33573

(57) ABSTRACT

A power converter is provided herein and comprises a cycloconverter comprising a first pair of AC FETs and a second pair of AC FETs and a controller configured to detect when at least one of a to-be fault or an ongoing fault occurs and open or close at least one of the first pair of AC FETs or the second pair of AC FETs such that remanent energy stored in a resonant tank of the power converter is depleted to a grid without causing the first pair of AC FETs or the second pair of AC FETs to avalanche.

### CROSS-REFERENCE TO RELATED APPLICATIONS

The present application claims the benefit of and priority to India Provisional Application No. 202311044294, filed on Jul. 2, 2023, the entire contents of which is incorporated herein by reference.

### BACKGROUND

### Field of the Disclosure

Embodiments of the present disclosure relate generally to cycloconverters and, for example, to switching methods and apparatus configured for use with cycloconverters.

### Description of the Related Art

Conventional power converters (e.g., microinverters) suitable for use with power conversion systems are known. The power converters can comprise a cycloconverter that comprises one or more switches, which can comprise one or more FETs. When there is a state that calls for ceasing of switch operations during operation of the microinverter, an entire tank energy can be dumped across an AC side of the one or more FETs. Even though the energy stored in a resonant tank on the AC side may be relatively small, current flowing through the resonant tank can avalanche the one or more FETs (e.g., on the instance of opening the switches), which can damage the one or more switches.

To overcome the unwanted avalanche current, a FET with high avalanche current/energy rating drawback can sometimes be used, but very few off the shelf FETs meet the avalanche current requirements, e.g., because semiconductor manufacturers regularly reduce die size as technology advances, which can result in unique outsourcing and supply chain constrains. Additionally, customized FETs are, typically, very expensive.

Alternatively, to overcome the unwanted avalanche current, some solutions comprise ensuring that all possible states of the switches open at tank current zero cross. For example, tank current can be measured to ensure that the cycloconverter is turned off at zero-cross of tank current. While such solutions are suitable, due to ADC measurement error and propagation delay of a driver ICs/ASIC, the AC switches can still see avalanche current with reduced magnitude. Thus, since new generation Si FETs have extremely low avalanche rating, and GaN FETs have no avalanche rating, such solutions only solves part of the problem.

Thus, there is a need for improved switching methods and apparatus configured for use with cycloconverters.

### SUMMARY

In accordance with at least some embodiments, a power converter can comprise a cycloconverter comprising a first pair of AC FETs and a second pair of AC FETs and a controller configured to detect when at least one of a to-be fault or an ongoing fault occurs and open or close at least one of the first pair of AC FETs or the second pair of AC FETs such that remanent energy stored in a resonant tank of the power converter is depleted to a grid without causing the first pair of AC FETs or the second pair of AC FETs to avalanche.

In accordance with at least some embodiments, a method for controlling switching in a power converter can comprise detecting when at least one of a to-be fault or an ongoing fault occurs and opening or closing at least one of a first pair of AC FETS or a second pair of AC FETS such that remanent energy stored in a resonant tank of the power converter is depleted to a grid without causing the first pair of AC FETS or the second pair of AC FETS to avalanche.

In accordance with at least some embodiments, a non-transitory computer readable storage medium has instructions stored thereon that when executed by a process performs a method for controlling switching in a power converter comprising detecting when at least one of a to-be fault or an ongoing fault occurs and opening or closing at least one of a first pair of AC FETS or a second pair of AC FETS such that remanent energy stored in a resonant tank of the power converter is depleted to a grid without causing the first pair of AC FETS or the second pair of AC FETS to avalanche.

Various advantages, aspects, and novel features of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic diagram of a power conversion system comprising a switched mode power converter, in accordance with embodiments of the present disclosure;

FIG. 2 is a schematic diagram of a power conversion system comprising a switched mode power converter, in accordance with embodiments of the present disclosure;

FIGS. 3 to 5 are schematic diagrams of a power converter comprising switches in various configurations, in accordance with embodiments of the present disclosure;

FIG. 6 is a diagram of a simulation of results of a switching logic, in accordance with embodiments of the present disclosure; and

FIG. 7 is a flowchart of a method 700 for controlling switching in a power converter, in accordance with embodiments of the present disclosure.

### DETAILED DESCRIPTION

Embodiments of the present disclosure are directed improved switching methods and apparatus configured for use with cycloconverters. For example, a power converter can comprise a cycloconverter comprising a first pair of AC FETs and a second pair of AC FETs and a controller configured to detect when at least one of a to-be fault or an ongoing fault occurs and open or close at least one of the first pair of AC FETs or the second pair of AC FETs such that remanent energy stored in a resonant tank of the power converter is depleted to a grid without causing the first pair of AC FETs or the second pair of AC FETs to avalanche. The switching methods and apparatus described herein overcome the aforementioned shortcomings associated with convention methods and apparatus. For example, when there is a state that calls for ceasing of switch operations, the switching methods and apparatus described herein reduce, if not eliminate, the occurrence of FET avalanche.

The foregoing description of embodiments of the disclosure comprises a number of elements, devices, circuits and/or assemblies that perform various functions as described. These elements, devices, circuits, and/or assemblies are exemplary implementations of means for performing their respectively described functions.

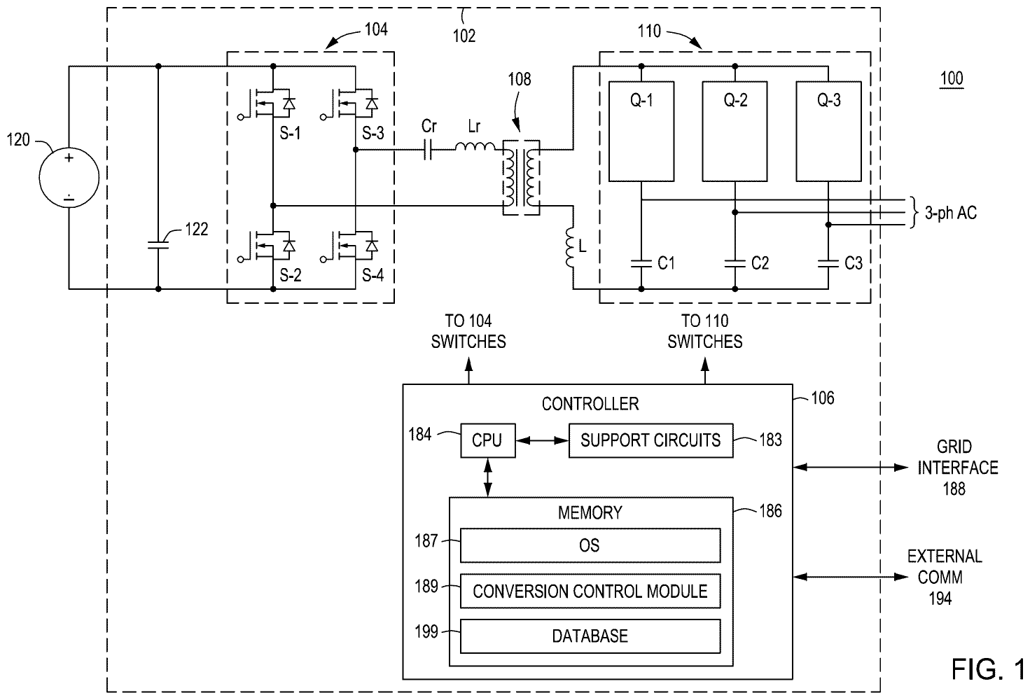

FIG. 1 is a schematic diagram of a power conversion system 100 comprising a converter 102 (e.g., a switched mode power converter) in accordance with embodiments of the present disclosure. This diagram only portrays one variation of the myriad of possible system configurations. The present disclosure can function in a variety of power generation environments and systems.

The power conversion system 100 comprises a DC component 120, such as a PV module or a battery, coupled to a DC side of the converter 102 (referred to herein as “converter 102”). In other embodiments the DC component 120 may be any suitable type of DC components, such as another type of renewable energy source (e.g., wind farms, hydroelectric systems, and the like), other types of energy storage components, and the like.

The converter 102 comprises a capacitor 122 coupled across the DC component 120 as well as across an H-bridge 104 formed from switches S-1, S-2, S-3 and S-4 which comprise one or more FETs, e.g., MOSFETs (Si, SiC, GaN, etc.). The switches S-1 and S-2 are coupled in series to form a left leg of the H-bridge 104, and the switches S-3 and S-4 are coupled in series to form a right leg of the H-bridge 104.

The output of the H-bridge 104 is coupled across a series combination of a capacitor Cr and inductor L, which form a resonant tank, and the primary winding of a transformer 108. In other embodiments, the resonant tank may be formed by a different configuration of the capacitor Cr and the inductor Lr (e.g., the capacitor Cr and the inductor L may be coupled in parallel); in some embodiments, Lr may represent a leakage inductance from the transformer 108 rather than a physical inductor.

A series combination of the secondary winding of the transformer 108 and an inductor L is coupled across a cycloconverter 110 which produces a three-phase AC output, although in other embodiments the cycloconverter 110 may produce one or two phases of AC at its output. The cycloconverter can be a bridge of unidirectional switches (which can conduct current in one direction when turned on) or bidirectional switches (which can conduct current in either direction when turned on) that are able to process AC energy. For illustrative purposes, the cycloconverter is shown as a bridge comprising bidirectional switches that can conduct current in either direction (when turned on), can block a voltage of either polarity (when turned off). The cycloconverter 110 comprises three 4Q bi-directional switches Q-1, Q-2, and Q-3 (which comprise one or more FETs, e.g., MOSFETs (Si, SiC, GaN, etc.) and which may be collectively referred to as switches Q) respectively in a first leg, a second leg, and a third leg coupled in parallel to one another.

The first cycloconverter leg comprises the 4Q switch Q-1 coupled to a capacitor C1, the second cycloconverter leg comprises the 4Q switch Q-2 coupled to a capacitor C2, and the third cycloconverter leg comprises a 4Q switch Q-3 coupled to a capacitor C3. A first AC output phase line is coupled between the switch Q-1 and the capacitor C1, a second AC output phase line is coupled between the switch Q-2 and the capacitor C2, and a third AC output phase line is coupled between the switch Q-3 and the capacitor C3. The converter 102 may also include additional circuitry not shown, such as voltage and/or current monitors, for obtaining data for power conversion, data reporting, and the like.

The converter 102 additionally comprises a controller 106 coupled to the H-bridge switches (S-1, S-2, S-3, and S-4) and the cycloconverter switches (Q-1, Q-2, and Q-3) for operatively controlling the switches to generate the desired output power. In some embodiments, the converter 102 may function as a bi-directional converter.

The controller 106 comprises a CPU 184 coupled to each of support circuits 183 and a memory 186. The CPU 184 may comprise one or more conventionally available microprocessors or microcontrollers. Additionally or alternatively, the CPU 184 may include one or more application specific integrated circuits (ASICs). The support circuits 183 are well known circuits used to promote functionality of the CPU 184. Such circuits include, but are not limited to, a cache, power supplies, clock circuits, buses, input/output (I/O) circuits, and the like. The controller 106 may be implemented using a general purpose computer that, when executing particular software, becomes a specific purpose computer for performing various embodiments of the present disclosure.

The memory 186 is a non-transitory computer readable storage medium such as random access memory, read only memory, removable disk memory, flash memory, and various combinations of these types of memory. The memory 186 is sometimes referred to as main memory and may, in part, be used as cache memory or buffer memory. The memory 186 generally stores the OS 187 (operating system), if necessary, of the controller 106 that can be supported by the CPU capabilities. In some embodiments, the OS 187 may be one of a number of commercially available operating systems such as, but not limited to, LINUX, Real-Time Operating System (RTOS), and the like.

The memory 186 may store various forms application software (e.g., instructions), such as a conversion control module 189 for controlling power conversion by the converter 102, for example maximum power point tracking (MPPT), switching, performing the methods described herein, and the like. The memory 186 may further store a database 199 for storing various data. The controller 106 further processes inputs and outputs to external communications 194 (i.e., gateway) and a grid interface 188.

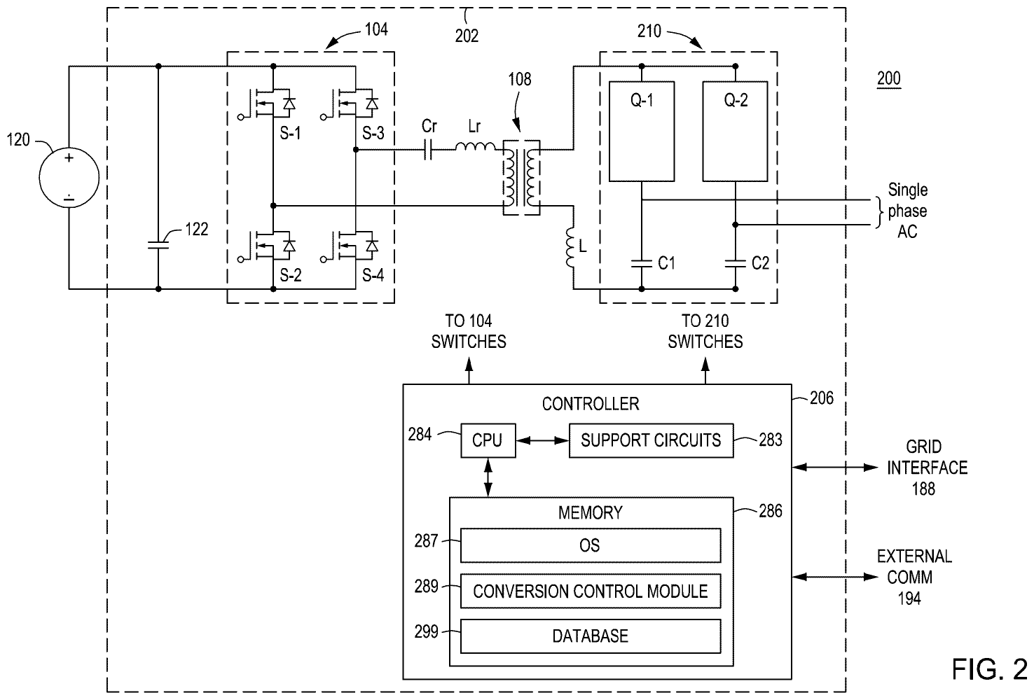

FIG. 2 is a schematic diagram of a power conversion system 200 comprising a converter 202 (e.g., a switched mode power converter) in accordance with embodiments of the present disclosure.

The power conversion system 200 comprises the DC component 120 coupled to a DC side of the converter 202. The converter 202 comprises the capacitor 122 coupled across the DC component 120 and the H-bridge 104, as described above with respect to the converter 102. The output of the H-bridge 104 is coupled across a series combination of the capacitor Cr and the inductor Lr, which form a resonant tank, and the primary winding of the transformer 108, as described above with respect to the converter 102. In other embodiments, the resonant tank may be formed by a different configuration of the capacitor Cr and the inductor Lr (e.g., the capacitor Cr and the inductor L may be coupled in parallel). In some embodiments, Lr may represent a leakage inductance (e.g., a leakage inductor) of the transformer 108 rather than a physical inductor.

A series combination of the secondary winding of the transformer 108 and the inductor L is coupled across a cycloconverter 210 which produces a single-phase AC output. As described above with respect to the converter 102, the cycloconverter can be a bridge of unidirectional switches (which can conduct current in one direction when turned on) or bidirectional switches (which can conduct current in either direction when turned on) that are able to process AC energy. For illustrative purposes, the cycloconverter is shown as a bridge comprising bidirectional switches. For example, the cycloconverter 210 comprises two bi-directional switches Q-1 and Q-2, (collectively referred to as switches Q) respectively in a first leg and a second leg coupled in parallel to one another.

The first cycloconverter leg comprises the 4Q switch Q-1 coupled to the capacitor C1, and the second cycloconverter leg comprises the 4Q switch Q-2 coupled to the capacitor C2. A first AC output phase line is coupled between the switch Q-1 and the capacitor C1, and a second AC output phase line is coupled between the switch Q-2 and the capacitor C2. The converter 202 may also include additional circuitry not shown, such as voltage and/or current monitors, for obtaining data for power conversion, data reporting, and the like.

The converter 202 additionally comprises a controller 206 coupled to the H-bridge switches (S-1, S-2, S-3, and S-4), and the cycloconverter switches (Q-1 and Q-2) for operatively controlling the switches to generate the desired output power. In some embodiments, the converter 202 may function as a bi-directional converter.

The controller 206 comprises a CPU 284 coupled to each of support circuits 283 and a memory 286. The CPU 284 may comprise one or more conventionally available microprocessors or microcontrollers. Additionally or alternatively, the CPU 284 may include one or more application specific integrated circuits (ASICs). The support circuits 283 are well known circuits used to promote functionality of the CPU 284. Such circuits include, but are not limited to, a cache, power supplies, clock circuits, buses, input/output (I/O) circuits, and the like. The controller 206 may be implemented using a general purpose computer that, when executing particular software, becomes a specific purpose computer for performing various embodiments of the present disclosure.

The memory 286 is a non-transitory computer readable medium such as random access memory, read only memory, removable disk memory, flash memory, and various combinations of these types of memory. The memory 286 is sometimes referred to as main memory and may, in part, be used as cache memory or buffer memory. The memory 286 generally stores the OS 287 (operating system), if necessary, of the controller 206 that can be supported by the CPU capabilities. In some embodiments, the OS 287 may be one of a number of commercially available operating systems such as, but not limited to, LINUX, Real-Time Operating System (RTOS), and the like.

The memory 286 may store various forms of application software, such as a conversion control module 289 for controlling power conversion by the converter 202, for example maximum power point tracking (MPPT), switching, and the like. The memory 286 may further store a database 299 for storing various data. The controller 206 further processes inputs and outputs to external communications 194 (i.e., gateway) and the grid interface 188.

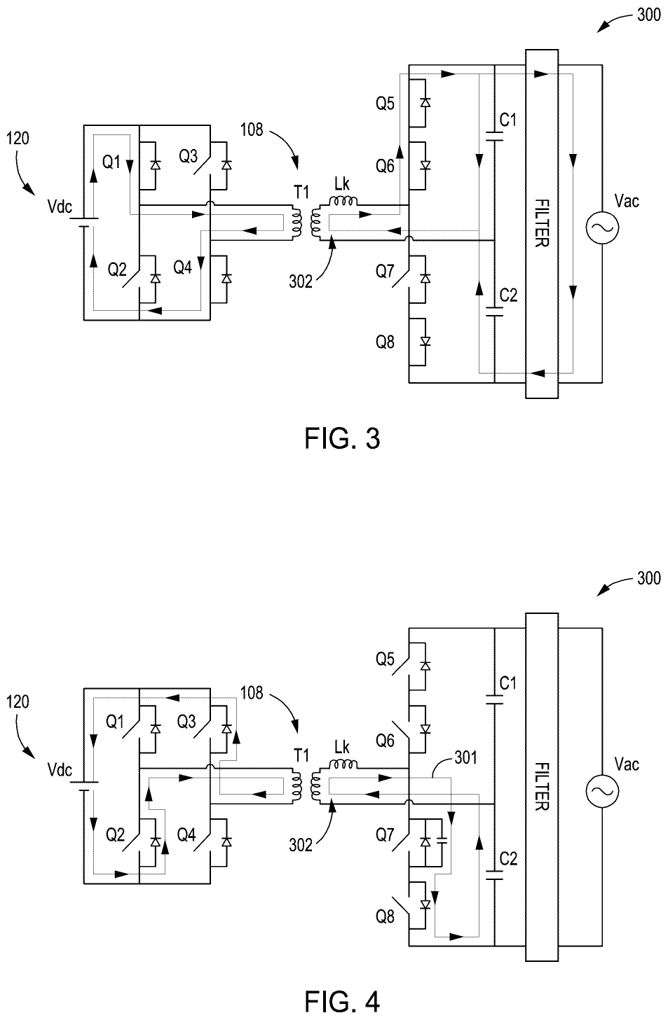

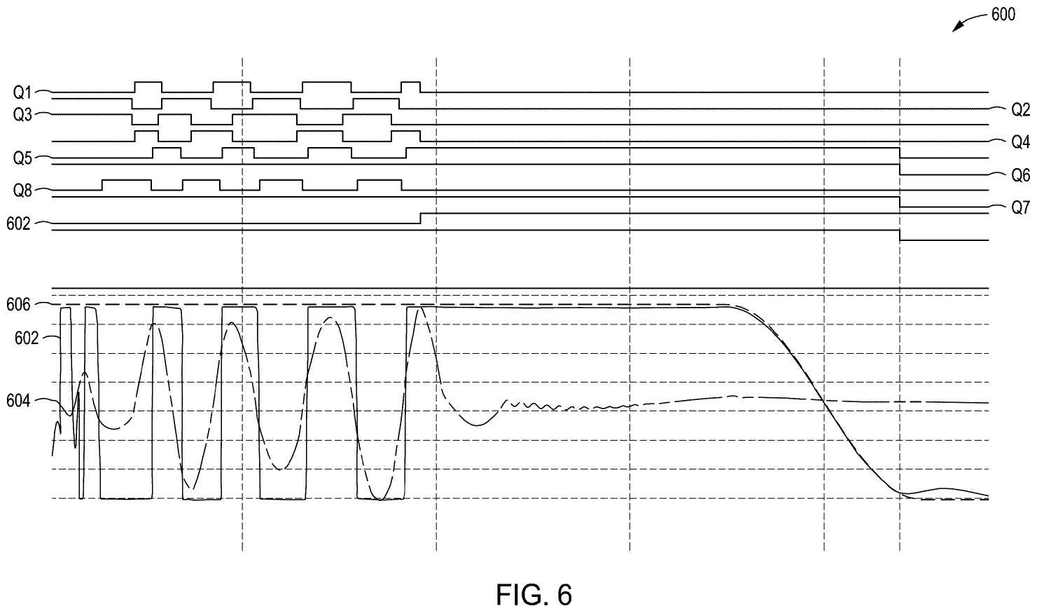

FIGS. 3 to 5 are schematic diagrams of a power converter 300 (e.g., the converter 102 or the converter 202) comprising switches in various configurations and FIG. 6 is a diagram of a simulation of results of a switching logic, in accordance with embodiments of the present disclosure.

For example, typical architecture of a microinverter can comprise a Full-Bridge (or H-Bridge) connected to the PV input/Battery (e.g., the DC component 120), a high frequency transformer (e.g., the transformer 108) for isolation/boost purposes, and a cycloconverter (e.g., the cycloconverter 110 and/or the cycloconverter 210) or the high frequency unfolding circuit. Such a power converter can be considered as a DC-DC converter with varying output DC operating points.

For an operating point—assuming that the power converter operates at unity power factor—at the positive AC-mains peak, the operating condition of the power converter can be defined by Equations (1)-(3).

$$Input = {V}_{D C} . \qquad ( 1 )$$

$$Output = {V}_{a c - p k} Output = {V}_{a c - p k} ( Positive of AC - mains ) . \qquad ( 2 )$$

$${I}_{req} = W / {V}_{a c} * √ 2. \qquad ( 3 )$$

Hence, at such an operating point, power-transfer switching states can be Switching State-1, which can be applicable for positive current of leakage (resonant) inductor and comprises Q1, Q4 being ON, Q2, Q3 being OFF, Q7 being OFF, and Q6, Q8, Q5 being ON (See FIG. 3, for example), and Switching State-2, which can be applicable for negative current of leakage (resonant) inductor and comprises Q1, Q4 being OFF, Q2, Q3 being ON, Q5 being OFF, and Q6, Q7, Q8 being ON.

Additionally, some power converters may rely on skips/faults detectors to recognize a to-be fault or an ongoing fault in a circuit. For example, each skip has a unique method of shutting down a power converter. For example, when a hard-skip is detected, a power converter immediately shuts-off, e.g., all MOSFETs are pushed to an OFF state as soon as the hard-skip is detected (see FIG. 4). For example, in such an abrupt shut down of a power converter, there is no path for the 7777697uu55resonant current to flow. Hence, the energy in a resonant tank 302 needs to dissipate on any of FETs (e.g., Q5 to Q8), depending upon the FETs prior switching state. The phenomenon of dumping the tank energy onto the FET causes the FET to avalanche, see Q7 in FIG. 4, which is shown avalanching after being in Switching State-1 (e.g., open).

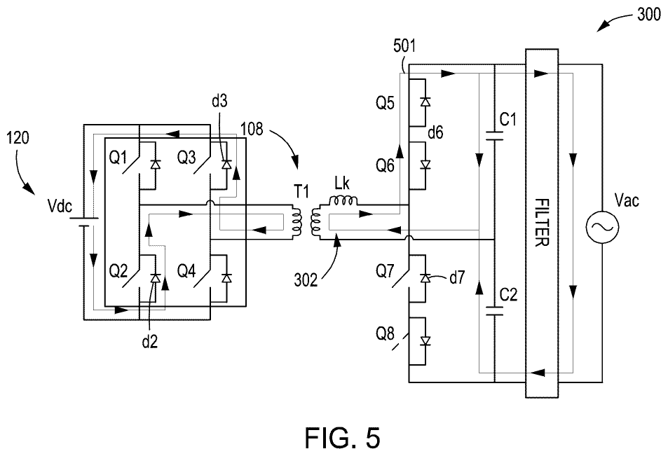

In at least some embodiments, taking the above operating point of the power converter 300, whenever a hard skip 602 (FIG. 6) is detected by the controller 106, the controller 106 shuts down (opens) the DC FETs Q1, Q2, Q3, Q4 (e.g., S1, S2, S3, S4), while controller 106 maintains the AC FETs Q5, Q6 (e.g., Q1), Q7, Q8 (e.g., Q2) in a prior switching state, e.g., Q5, Q6, and Q8 remain closed and Q7 remains open (e.g., see FIG. 5). By placing the switches in such a configuration, a resonant tank 302 of the transformer 108 dumps the resonant tank 302 remanent energy to the grid and provides the resonant tank 302 with an ample amount of time for the resonant tank energy to deplete, e.g., by switching off the power converter 300 at the subsequent zero crossing of the AC voltage. For example, the resonant current (e.g., 604 in FIG. 6) freewheels through the inherent body diodes (e.g., body diode d2 and body diode d3) of the DC FETs (e.g., Q2 and Q3) and through the AC FETs (e.g., Q5 and Q6) and prevents avalanche current (cf. current path 301 and Q7 of FIG. 4 with current path 501 and Q7 of FIG. 5). In FIG. 6, for example, Vₒᵤₜ (e.g., 606) is simulated such that after about 70 μs, the ACV falls steeply to about 0V, and there is no avalanche observed (e.g., 602, which is V_{(S6)}, Q7 drain to source Vas) and shutdown of the power converter is at about 10V.

In at least some embodiments, it may prove advantageous to turn off ACFETs just before the zero crossing, and if a zero crossing is missed, and the AC voltage continues to the negative half cycle (or positive half cycle) of the AC mains, a dead-short can occur due to Q7 body diode d7 conduction (or Q6 body diode d6). In such an occurrence, the controller 106 turns off Q8 too (e.g., opens Q8, shown in phantom) (or opens Q5, shown in phantom).

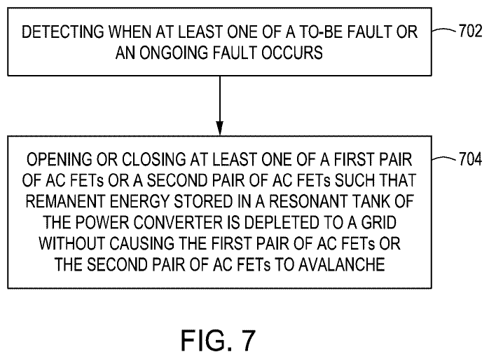

FIG. 7 is a flowchart of a method 700 for controlling switching in a power converter, in accordance with embodiments of the present disclosure. For example, the memory 186 can have instructions stored thereon instructions that when executed by a processor (e.g., the controller 106) perform the method 700 for controlling switching in a power converter (e.g., the converter 102 and/or the converter 202). For example, at 702 the method 700 comprises detecting when at least one of a to-be fault or an ongoing fault occurs. For example, the controller 106 can detect when one of a to-be fault or an ongoing fault occurs. For example, the controller 106 can detect when a hard-skip occurs.

Next, at 704, the method 700 comprises opening or closing at least one of a first pair of AC FETs or a second pair of AC FETs such that remanent energy stored in the resonant tank (e.g., the capacitor Cr and the inductor Lr) of the power converter is depleted to a grid without causing the first pair of AC FETs or the second pair of AC FETs to avalanche. For example, as described above, the controller can place the DC FETs in an open state (e.g., off state) and maintain the AC FETs in a prior switching state (e.g., one of switching states, Switching State-1 or Switching State-2). For example, Q5, Q6, and Q8 are maintained in the on state, and Q7 is maintained in the off state, thus allowing the remanent energy stored in the resonant tank of the power converter to be depleted to a grid without causing any of Q5, Q6, and Q8 to avalanche.

While the foregoing is directed to embodiments of the present disclosure, other and further embodiments of the disclosure may be devised without departing from the basic scope thereof, and the scope thereof is defined by the claims that follow.

1. A power converter, comprising:
a cycloconverter comprising a first pair of AC FETs and a second pair of AC FETs; and
a controller configured to detect when at least one of a to-be fault or an ongoing fault occurs and open or close at least one of the first pair of AC FETs or the second pair of AC FETs such that remanent energy stored in a resonant tank of the power converter is depleted to a grid without causing the first pair of AC FETs or the second pair of AC FETs to avalanche.

2. The power converter of claim 1, wherein the at least one of the to-be fault or the ongoing fault is a hard-skip which corresponds to when the power converter immediately shuts-off.

3. The power converter of claim 1, further comprising a first pair of DC FETs and a second pair of DC FETs.

4. The power converter of claim 3, wherein the first pair of AC FETs and the second pair of AC FETs are operable in switching states applicable for positive current and negative current of a leakage inductor of the resonant tank, and wherein in the switching states at least three FETs of the first pair of AC FETs and the second pair of AC FETs are on, two FETs of the first pair of DC FETs and the second pair of DC FETs are on, and two FETs of the first pair of DC FETs and the second pair of DC FETs are off.

5. The power converter of claim 1, wherein the controller is further configured to switch off the power converter at a zero crossing of AC voltage subsequent to when at least one of the to-be fault or the ongoing fault is detected.

6. The power converter of claim 1, wherein the first pair of AC FETs and the second pair of AC FETs are MOSFETs comprising at least one of Si, SiC, or GaN.

7. A method for controlling switching in a power converter, comprising
detecting when at least one of a to-be fault or an ongoing fault occurs; and
opening or closing at least one of a first pair of AC FETS or a second pair of AC FETS such that remanent energy stored in a resonant tank of the power converter is depleted to a grid without causing the first pair of AC FETS or the second pair of AC FETS to avalanche.

8. The method of claim 7, wherein the at least one of the to-be fault or the ongoing fault is a hard-skip which corresponds to when the power converter immediately shuts-off.

9. The method of claim 7, further comprising a first pair of DC FETs and a second pair of DC FETs.

10. The method of claim 9, wherein the first pair of AC FETs and the second pair of AC FETs are operable in switching states applicable for positive current and negative current of a leakage inductor of the resonant tank, and wherein in the switching states at least three FETs of the first pair of AC FETs and the second pair of AC FETs are on, two FETs of the first pair of DC FETs and the second pair of DC FETs are on, and two FETs of the first pair of DC FETs and the second pair of DC FETs are off.

11. The method of claim 7, further comprising switching off the power converter at a zero crossing of AC voltage subsequent to when at least one of the to-be fault or the ongoing fault is detected.

12. The method of claim 7, wherein the first pair of AC FETs and the second pair of AC FETs are MOSFETs comprising at least one of Si, SiC, or GaN.

13. A non-transitory computer readable storage medium having instructions stored thereon that when executed by a process performs a method for controlling switching in a power converter, comprising
detecting when at least one of a to-be fault or an ongoing fault occurs; and
opening or closing at least one of a first pair of AC FETs or a second pair of AC FETs such that remanent energy stored in a resonant tank of the power converter is depleted to a grid without causing the first pair of AC FETs or the second pair of AC FETs to avalanche.

14. The non-transitory computer readable storage medium of claim 13, wherein the at least one of the to-be fault or the ongoing fault is a hard-skip which corresponds to when the power converter immediately shuts-off.

15. The non-transitory computer readable storage medium of claim 13, further comprising a first pair of DC FETs and a second pair of DC FETs.

16. The non-transitory computer readable storage medium of claim 15, wherein the first pair of AC FETs and the second pair of AC FETs are operable in switching states applicable for positive current and negative current of a leakage inductor of the resonant tank, and wherein in the switching states at least three FETs of the first pair of AC FETs and the second pair of AC FETs are on, two FETs of the first pair of DC FETs and the second pair of DC FETs are on, and two FETs of the first pair of DC FETs and the second pair of DC FETs are off.

17. The non-transitory computer readable storage medium of claim 13, further comprising switching off the power converter at a zero crossing of AC voltage subsequent to when at least one of the to-be fault or the ongoing fault is detected.

18. The non-transitory computer readable storage medium of claim 13, wherein the first pair of AC FETs and the second pair of AC FETs are MOSFETs comprising at least one of Si, SiC, or GaN.
